(19) United States
(12) Patent Application Publication
(10) Pub. No.: US 2004/0092759 A1
(43) Pub. Date: May 13, 2004

(54) Process for making haloalkylalkoxysilanes

(76) Inventors: Mark D. Westmeyer, Marietta, OH (US); Mark P. Bowman, New Kensington, PA (US); Curtis L. Schilling JR., Marietta, OH (US); Michael R. Powell, New Martinsville, WV (US)

Correspondence Address: Michael P. Dilworth, CROMPTON CORPORATION, Benson Road, Middlebury, CT, 06749, US

(21) Appl. No.: 10/293,166

(22) Filed: Nov. 12, 2002

(51) Int. Cl. C07F 7/08

(52) U.S. Cl. 556/457

(57) ABSTRACT

A haloalkylalkoxysilane is prepared by reacting an olefinic halide with an alkoxysilane in which the alkoxy group(s) contain at least two carbon atoms in the presence of a catalytically effective amount of ruthenium-containing catalyst. The process can be used to prepare, inter alia, chloropropyltriethoxysilane which is a key intermediate in the manufacture of silane coupling agents.

### FIELD OF THE INVENTION

This invention relates to a process for making certain haloorganosilicon compounds. More particularly, the invention relates to a process for the preparation of haloalkylalkoxysilanes such as chloropropyltriethoxysilane.

### BACKGROUND OF THE INVENTION

Chloropropyltriethoxysilane is a key intermediane for the preparation of a variety of amino-, mercapto- and methacryloyloxyorganosilanes for use as silane coupling agents.

U.S. Pat. No. 6,191,297 describes a two step process involving the ethanol esterification of the product obtained from the platinum-catalyzed hydrosilation reaction of trichlorosilane and allyl chloride. This process is highly material- and plant-intensive due to low yields and significant byproduct formation, i.e., propyltrichlorosilane.

A potentially more economical route is the direct hydrosilation reaction of triethoxysilane and allyl chloride. Platinum is the most widely used hydrosilation catalyst and its use for the hydrosilation reaction of allyl chloride and triethoxysilane has been reported. According to U.S. Pat. No. 3,795,656, a 70% yield was obtained for the Pt-catalyzed hydrosilation reaction of allyl chloride and triethoxysilane. Belyakova et al., Obshch. Khim 1974, 44, 2439-2442, describes the Pt-catalyzed hydrosilation reaction of silanes with allyl chloride and reports a 14% yield for chloropropyltriethoxysilane. As disclosed in Japanese Patent No. 11,199,588, the Pt-catalyzed hydrosilation reaction of trimethoxysilane and allyl chloride resulted in a 70% yield of chloropropyltrimethoxy-silane.

The primary limitation with the hydrosilation reaction of allyl chloride and a silane is a competing elimination reaction. With platinum, the competing elimination reaction is more prevalent with alkoxysilanes than with chlorosilanes. Rhodium and palladium afford primarily elimination products.

Iridium has been reported to be a very efficient catalyst for the hydrosilation reaction of allyl chloride and triethoxysilane. According to U.S. Pat. No. 5,616,762, the iridium-catalyzed hydrosilation reaction of triethoxysilane and allyl chloride is said to be very selective for chloropropyltriethoxysilane with minimal byproducts. Japanese Patent Appl. 4[1992]-225170 reports similar results for the iridium-catalyzed hydrosilation reaction of allyl chloride and trimethoxysilane. In U.S. Pat. No. 4,658,050, the iridium-catalyzed hydrosilation reaction of alkoxysilanes and allyl chloride utilizes olefin iridium complexes.

Ruthenium has been reported to be a very efficient catalyst for the hydrosilation reaction of allyl chloride and trimethoxysilane. Japanese Patent No. 2,976,011 discloses the Ru-catalyzed hydrosilation reaction of triethoxysilane and allyl chloride to give chloropropyltriethoxysilane in about 41% yield. U.S. Pat. No. 5,559,264 describes the ruthenium-catalyzed hydrosilation reaction of methoxysilanes and allyl chloride to provide a chloroalkylalkoxysilane. Tanaka et al., J. Mol. Catal. 1993, 81, 207-214 report the ruthenium carbonyl-catalyzed hydrosilation reaction of trimethoxysilane and allyl chloride and Japanese Paten Appl. 8[1996]-261232 describes the activation of ruthenium carbonyl for use as a hydrosilation catalyst for the same reaction.

### SUMMARY OF THE INVENTION

In accordance with the present invention, a process is provided for preparing a haloalkylalkoxysilane of the formula

(R¹)ₓ(R²O)₃₋ₓSiCH₂CHR³CR⁴R⁵X

wherein R¹ is an alkyl of from 1 to 6 carbon atoms, R² is an alkyl of from 2 to 6 carbon atoms, R³ is an alkyl group of 1 to 6 carbon atoms or hydrogen, R⁴ is an alkyl of from 1 to 6 carbon atoms, hydrogen or halogen, R⁵ is an alkyl of from 1 to 6 carbon atoms and x is 0, 1 or 2, which comprises reacting in the substantial absence of aromatic solvent an olefinic halide of the formula

H₂C═CR³CR⁴R⁵X

wherein R³, R⁴, R⁵ and X have the aforestated meanings, with a molar excess of alkoxysilane of the formula

(R¹)ₓ(R²O)₃₋ₓSiH

wherein R¹ and R² have the aforestated meanings, in the presence of a catalytically effective amount of ruthenium-containing catalyst.

The foregoing reaction of olefinic halide and alkoxysilane to provide a haloalkylalkoxysilane can be considered to proceed in accordance with the reaction:

$${H}_{2} C = {CR}^{3} {CR}^{4} {R}^{5} X + {( {R}^{1} )}_{x} {( {R}^{2} O )}_{3 - x} SiH {{\to }^{ Heat }}_{Ru cat .} {( {R}^{1} )}_{x} {( {R}^{2} O )}_{3 - x} {SiCH}_{2} {CHR}^{3} {CR}^{4} {R}^{5} X$$

wherein R¹, R², R³, R⁴, R⁵, X and x have the meanings stated above.

The process herein can be performed in a variety of commercially available equipment now used for hydrosilation reactions, including equipment in which such reactions are performed in continuous fashion.

By integrating the present process with, e.g., a source of triethoxysilane, prepared directly from silicon metal and ethanol, one can avoid the use of corrosive and hazardous hydrochlorosilanes and eliminate the generation of large amounts of chlorine-containing waste by-products which are inherent to the use of products derived from hydrochlorosilanes.

### DETAILED DESCRIPTION OF THE INVENTION

It has surprisingly been discovered that several factors are important for obtaining high yields of haloalkylalkoxysilanes from a one-step hydrosilation reaction between an olefinic halide and an alkoxy silane. First, when all reactants are combined at the start in a batch reaction, selectivity to the desired haloalkylalkoxysilane is highest at lower temperatures and lower reaction rates. Second, when temperature is increased to improve reaction rates, selectivity can be maintained by limiting the concentration of olefinic halide in the reaction mixture. Third, most inert solvents, and particularly aromatic solvents, have a deleterious effect on rates, selectivities, or both, particularly in a batch system and therefore should ordinarily be excluded from the reaction medium.

Preferably, the process is carried out by slowly adding the olefinic halide to a reactor containing the alkoxysilane and reacting them in the presence of a ruthenium metal-containing catalyst in either a semi-batch or continuous process. This order of addition effectively maintains a minimum concentration of unreacted olefinic halide in the reaction medium relative to the alkoxysilane, and thus effectively establishes a very large molar excess of the alkoxysilane relative to the olefinic halide in the reaction medium. In general practice, the maximum rate of addition of the olefinic halide to the alkoxysilane will be determined by the reaction rate, which is dependent in part on the reaction temperature and the catalyst concentration, and by the heat transfer limitations of the reaction equipment, whether a small laboratory reactor or a very large commercial reactor is used, as will be understood by one skilled in the art.

The preferred order of combination can be achieved in semi-batch or continuous operation. In semi-batch operation, a reactor first is charged with a large portion of, and preferably with the full complement of, the molar excess of alkoxysilane. Thereafter, the olefinic halide is slowly added to the reactor and the olefinic halide and alkoxysilane are reacted in the presence of the ruthenium catalyst. As used herein, slow addition of olefinic halide generally means at a rate below about 3 moles of olefinic halide per hour per mole of alkoxysilane, and preferably at or below 1 mole per hour per mole of alkoxysilane. For example, in a semi-batch process, an addition rate of 2 moles of olefinic halide/hr/mole of alkoxysilane is practiced when 1 mole of olefinic halide is added to a reactor containing 2 moles of alkoxysilane in 15 minutes. Once the olefinic halide has been added to the reactor, the reaction is continued until complete conversion of the olefinic halide is obtained. While this, in large part, is a function of temperature and catalyst concentration, complete conversion generally can be achieved in 1 to 15 hours and more usually between 1 to 10 hours. Completion of the reaction in 1 to 5 hours is not unusual. Some portion of the alkoxysilane can also be added in admixture with the olefinic halide or simultaneously with the addition of the olefinic halide as a separate stream.

In continuous operation, the reactor typically is charged with separate streams of the olefinic halide and alkoxysilane at a mole ratio of alkoxysilane to olefinic halide of from about 1.3 to about 3.0, and preferably at a mole ratio of from about 1.8 to about 2.3. Such operation ensures a proper excess of alkoxysilane in the reaction vessel under steady state operating conditions. For the preferred alkoxysilane, ethoxysilane, and preferred olefinic halide, allylic chloride, the preferred mole ratio is from about 1.6 to about 2.3.

Solvents which have been found to have a negative effect on hydrosilation rates, selectivities, or both, in at least certain instances include common aromatic hydrocarbon solvents such as benzene, toluene, xylenes, cumene, other alkylated benzenes, and higher aromatics in alkylated or unalkylated form. While toluene degrades selectivity in a batch system, when the process is performed in accordance with the preferred embodiment by adding olefinic halide to the molar excess of alkoxysilane, the presence of toluene solvent has a reduced adverse impact on selectivity to the desired product. Selectivity can be maintained at or near the desired level at the expense of a lower reaction rate and a lower yield per unit volume of the equipment. Other solvents which have negative effects on rate, selectivity, or both, include alkanes such as hexane, nitrites such as acetonitrile, ethers such as isopropyl ether, haloalkanes such as dichloroethane, ketones such as acetone, and alcohols such as ethanol. Because the process of the invention is essentially quantitative and rapid under preferred operating conditions, further promotion of rates and enhancement of yields by using a solvent is unlikely. Thus, use of a solvent generally should be avoided.

As noted, the process of the present invention does not require, and preferably avoids, the use of inert solvents, since they generally have a negative effect on rate, selectivity, or both, and their use reduces the yield per unit volume of the production equipment. By avoiding any need for a solvent, the process of the present invention increases the effective yield of the desired haloalkylalkoxysilane whether calculated on a molar basis or calculated per unit volume of the production equipment. Thus, a preferred embodiment of the invention is to conduct the process in the substantial absence of inert solvent. As used herein, in “substantial absence” means less than 1%, preferably less than 0.5%, and more preferably no appreciable amount of solvent. As used here, the phrase “inert solvent” excludes the reactants and products of the desired hydrosilation. In the broadest practice of the invention, however, use of such solvents is optional and the noted disadvantage may be outweighed in certain cases for non-chemical reasons such as viscosity reduction of the reaction medium to promote rapid filtration, or for safety reasons including providing a heat sink.

Other hydrosilation reaction conditions, such as temperature, mole ratios of reactants, pressure, time, and catalyst concentration, are not narrowly critical. One has a wide latitude in adjusting these factors to use various pieces of production equipment economically and safely. Such equipment will typically have provisions for heating, cooling, agitation, maintenance of inert atmospheres and purification, as by filtration or distillation. Thus, equipment typically used in the prior art for large scale commercial hydrosilation reactions can be used for the process of the present invention, including equipment wherein olefinic halide is added to a refluxing, condensable stream of hydrosilicon compound in a zone containing a heterogeneous supported hydrosilation catalyst.

Reaction conditions can include a reaction temperature of from about 60 to about 130° C. with from about 70 to about 80° C. being preferred. Generally, the process is performed at a pressure at or above atmospheric pressure with atmospheric pressure being preferred. It is recognized that the process of the present invention may provide a high yield of the desired chloroalkylalkoxysilane in a truly batch system; however, a batch reaction will typically be conducted at a lower temperature with consequently longer reaction times. Thus, it is preferred to perform the hydrosilation at an elevated temperature by adding the olefinic halide to a molar excess of the alkoxysilane in the presence of the ruthenium metal-containing catalyst. One particular preferred mode of operation (semi-batch) involves slowly adding the full complement of olefinic halide over a period of time, to obtain a rate of addition of less than 3 moles of olefinic halide per hour per mole of alkoxysilane, to a reactor containing the full complement of the alkoxysilane, for example, from about 1.6 to about 2.3 molar equivalents of triethoxysilane relative to the full amount of allyl halide to be added. Preferably, the reactor contains 5 to 50 parts per million of ruthenium as RuCl₃ hydrate by weight of total reactants and the reaction is conducted at from about 70° C. to about 80° C. and preferably from about 75 to about 80° C. Excess alkoxysilane and the ruthenium catalyst can be recycled effectively to the next batch.

Since the process of the present invention is nearly quantitative with respect to the conversion of olefinic halide to the desired haloalkylalkoxysilane product, particularly in the reaction of allyl chloride with triethoxysilane to provide chloropropyltriethoxysilane, the generation of undesired by-products is greatly lowered. This reduces the amounts of materials to be destroyed or discarded as waste, to be isolated as separate streams, as by distillation, or to be vented from the reaction system. Since the process of the present invention is highly exothermic, external heating is not normally necessary, and reaction times are correspondingly shorter. Generally, the only impurities in significant amounts that need to be removed from the reaction product are the small excess of unreacted alkoxysilane and residual catalyst. These may be recycled to the next batch without purification. The low level of residual halide that may be present in the product can be neutralized by methods well known in the art. Where the hydrosilation product of the present invention is used as an intermediate for the production of other organofunctional silicon compounds, its purity on initial synthesis may be sufficient that further purification, such as by distillation, may not be needed.

When applied, e.g., to the preparation of chloropropyltriethoxysilane, the process of the present invention provides a higher yield of this product, calculated on a molar basis from the limiting reactant, than any one-step or two-step process described in the prior art. The process also obtains such yields using significantly lower levels of ruthenium metal-containing catalyst than any process described in the art. The process also provides a higher yield per unit volume of equipment used, since use of inert solvents is obviated and significant quantities of waste by-products are not generated. The preferred order of combination of reactants in the present invention is in fact opposite to that employed to maximize the yield of chloropropyltrichlorosilane from one reported platinum-catalyzed reaction of trichlorosilane with allyl chloride. Moreover, the obtained yield is significantly higher than that reported for the platinum-catalyzed reaction of triethylsilane with allyl chloride, which is maximized by the addition of allyl chloride, necessarily containing trichlorosilane as a hydrosilation promoter, to the triethylsilane. The process of the present invention does not require the presence of a second hydrosilicon compound as a promoter.

While the process of the present invention does not require operation at a pressure above atmospheric pressure, an elevated pressure may be used, for example up to two atmospheres pressure, to control inadvertent potential emissions of allyl halide to the environment by using a closed reactor. A pressure below atmospheric pressure may be used if a reaction temperature below the atmospheric pressure boiling point of the alkoxysilane is desired.

Olefinic halides which are suitable for use herein include allyl chloride, allyl bromide, methallyl chloride, methallyl bromide, 3-chloro-1-butene, 3,4-dichloro-1-butene, 2-chloropropene, and the like. Of these, allyl chloride, CH₂═CH₂CH₂Cl, is preferred.

Alkoxysilanes which are suitable for use in the present invention include triethoxysilane, methyldiethoxysilane, dimethylethoxysilane, ethyldiethoxysilane, diethylethoxysilane, tripropyloxysilane, methyldipropyloxy-silane, tributyloxysilane, and the like. Of these alkoxysilanes, the ethoxysilanes are preferred with triethoxysilane being more preferred.

The ruthenium metal-containing catalyst must be present in the reaction medium and can be added in solution with the alkoxysilane, or with the olefinic halide, or both, or may be present in heterogeneous form in a catalytic zone to which the reactants are introduced. A variety of homogeneous and heterogeneous forms of ruthenium metal-containing compounds can be used as catalysts, and use levels (based on contained metal) can be as low as those of commercially practiced platinum-catalyzed hydrosilation reactions. For example, ruthenium concentrations between about 2 and 300 ppm are generally suitable.

If oxygen is needed for catalyst activation, the amount of oxygen normally present in commercial raw materials, especially the reactants themselves, should generally be sufficient. This is particularly true for ruthenium carbonyl catalysts. If further catalyst activation is necessary, such can be accomplished simply by adding dilute oxygen, as for example, a mixture of 3% O.sub.2 in N.sub.2, to one or more of the reactants, or to the reaction medium to elevate the oxygen level encountered by the catalyst. Separate activation may more likely be required when the catalysts are ruthenium-phosphine complexes.

Suitable ruthenium-metal containing catalysts can be selected from homogeneous and heterogeneous ruthenium metal-containing compounds and complexes including the following: Ru₃(CO)₁₂, [Ru(CO)₃Cl₂]₂; cyclooctadiene-RuCl₂; RuCl₃, (Ph₃P)₂Ru(CO)₂Cl₂; (Ph₃P)₃Ru(CO)H₂; Ru on Fe; Ru on Al₂O₃; Ru on carbon; Ru(AcAc)₃; RuBr₃ and the like where Ph is a phenyl group and AcAc is an acetylacetonate group.

Ruthenium metal-containing compounds constituting ruthenium complexes containing only triphenylphosphine, hydrogen and chlorine ligands such as (Ph₃P)₃RuCl₂, (Ph₃P)₃RuHCl and (Ph₃P)₃RuH₂ are ineffective as catalysts for the reaction of trimethoxysilane with olefinic halide in the presence or absence of oxygen. This lack of catalytic activity is consistent with the results of prior investigators who examined the hydrosilation of allyl chloride with triethoxysilane. Where phosphine ligands are present, ligands other than or in addition to hydrogen or chlorine, e.g., carbonyl and olefin ligands, should also be present and a slightly higher level of activating oxygen may be needed.

The preferred ruthenium catalysts are the ruthenium carbonyl compounds, with Ru₃(CO)₁₂ and [Ru(CO)₃Cl₂]₂ being more preferred. Catalyst from one batch can be recycled to the next batch without significant loss of activity. Catalyst use level may be in the range of 5.0 to 300 parts per million of contained Ru metal based on the total reactant charge, with 5 to 50 parts per million being preferred.

The haloalkylalkoxysilane products of the process of the present invention maybe purified by standard means, as by distillation, or where used as intermediates for a subsequent preparation, may be used directly without intermediate purification.

As noted above, the reaction also can be conducted in a continuous fashion by adding the alkoxysilane and olefinic halide reactants to the reactor at the desired molar excess of the silane. At steady state, the reactor will contain a sufficient excess of the alkoxysilane in admixture with product haloalkylalkoxysilane to allow substantially quantitative yield of the desired product. The excess alkoxysilane can conveniently be recovered from the product stream and recycled.

Whereas the exact scope of the present invention is set forth in the appended claims, the following specific examples illustrate certain aspects of the present invention and, more particularly, point out the various aspects of the method for evaluating same. However, the examples are set forth for illustrative purposes only and are not to be construed as limitations on the present invention. The abbreviations g, ppm, equiv., GC and TES respectively represent grams, parts per million, molar equivalent, gas chromatography and triethoxysilane. Temperature is given in degrees centigrade. Yield percentages are determined by GC using an internal standard, except where yields are determined by actual weight, following vacuum distillation of the product. Unless stated otherwise, all reactions were run in standard laboratory glassware at atmospheric pressure under an inert atmosphere of nitrogen. In each example, product structures were identified by GC, GC/mass spectrometry, infrared spectroscopy, or nuclear magnetic resonance.

All of the reactions in the following examples were carried out under a nitrogen atmosphere. Allyl chloride (98%, Aldrich Chem.), triethoxysilane (99%, TES, OSi Specialties), methyldiethoxysilane (OSi Specialties), dimethylethoxysilane (Gelest, Inc.), RuCl₃ hydrate (Johnson Matthey) were used without further purification. All other silanes were purchased from Gelest, Inc. and all olefins were purchased from either Aldrich Chem. or Acros and used without any further purification. TES was distilled using a 5 tray Oldershaw column under atmospheric pressure and stored in either a glass or stainless steel bottle. Typical TES purity was ˜98% and contained <200 ppm toluene (wt/wt). All GC data is expressed in weight mass % (wt/wt).

### EXAMPLES 1-13

Each reaction in Examples 1-13 was conducted by treating 1.6-2.4 mole equivalents (vs. allyl chloride) of TES at ambient temperature with a promoter (if applicable), 15-50 ppm Ru (as a solid RuCl₃ hydrate or a 2-4% Ru ethanol/1,2-dimethoxyethane solution) versus total mass of the reaction. This solution was warmed. At ˜70-120° C., the solution was treated with 1.0 mole equivalent of allyl chloride. The addition of allyl chloride typically resulted in a mild exothermic reaction, which subsided after ˜20-30% of the allyl chloride had been added. The solution's temperature was maintained between 70-120° C. throughout this addition. After the allyl chloride addition was completed, the solution's temperature was maintained at ˜70-120° C. for one hour. After this time, this solution was allowed to cool to ambient temperature, and an aliquot of the crude reaction was analyzed with GC.

In Example 1 at ambient temperature, 160.74 g of TES was treated with 0.0268 g of RuCl₃ hydrate (50 ppm Ru) and warmed. At ˜80° C., the TES solution was treated with 46.34 g of allyl chloride. After the allyl chloride addition was completed, the solution was maintained at 80° C. for 1 hour. An aliquot of the solution was analyzed with GC. The results were as follows:

| Allyl | | | | | | |
|---|---|---|---|---|---|---|
| chloride | (EtO)₃SiH | (EtO)₃SICl | (EtO)₄Si | (EtO)₃SIC₃H₇ | Cl(EtO)₂SiC₃H₇Cl | (EtO)₃SiC₃H₇Cl |
| 0.49 | 34.45 | 4.77 | 5.55 | 14.02 | 1.39 | 48.41 |

The GC data for Examples 2-12 are set forth in Table 1 as follows:

TABLE 1
GC data for the Ru-catalyzed hydrosilation reaction of TES and allyl chloride.*

| | | allyl | | | | | | |
|---|---|---|---|---|---|---|---|---|
| Example | Conditions | chloride | (EtO)₃SiH | (EtO)₃SICl | (EtO)₄Si | (EtO)₃SIC₃H₇ | Cl(EtO)₂SiC₃H₇Cl | (EtO)₃SiC₃H₇Cl |
| | Mole excess | | | | | | | |
| | of TES | | | | | | | |
| 2 | 60% | 0.01 | 15.86 | 8.12 | 6.47 | 14.56 | 1.22 | 46.95 |
| | Normalized | 0.01 | — | 10.10 | 8.05 | 18.10 | 1.52 | 58.38 |
| | for excess | | | | | | | |
| | TES | | | | | | | |
| 3 | 80% | 0.01 | 26.86 | 5.45 | 4.37 | 10.82 | 0.60 | 47.28 |
| | Normalized | 0.01 | — | 7.73 | 6.20 | 15.34 | 0.85 | 67.04 |
| | for excess | | | | | | | |
| | TES | | | | | | | |
| 4 | 100% | 0.01 | 32.622 | 4.605 | 3.725 | 9.22 | 0.57 | 45.21 |
| | Normalized | 0.01 | — | 7.07 | 5.72 | 14.17 | 0.88 | 69.47 |
| | for excess | | | | | | | |
| | TES | | | | | | | |
| 5 | 120% | 0.01 | 37.23 | 4.47 | 4.00 | 8.38 | 0.51 | 41.27 |
| | Normalized | 0.01 | — | 7.56 | 6.67 | 14.18 | 0.86 | 69.82 |
| | for excess | | | | | | | |
| | TES | | | | | | | |
| 6 | 134% | 0.01 | 40.67 | 3.83 | 3.43 | 7.63 | 0.33 | 40.34 |
| | Normalized | 0.01 | — | 6.70 | 5.99 | 13.34 | 0.58 | 70.53 |
| | for excess | | | | | | | |
| | TES | | | | | | | |
| 7 | temperature | 20.49 | 69.31 | 2.08 | 2.75 | 0.94 | 0.18 | 0.81 |
| | (° C.) | | | | | | | |
| | ˜25 (after | | | | | | | |
| | 18 hours) | | | | | | | |
| 8 | 70 | 0.01 | 23.85 | 8.11 | 8.02 | 9.14 | 1.44 | 43.91 |
| 9 | 80 | 0.01 | 15.86 | 8.12 | 6.47 | 14.56 | 1.22 | 46.95 |
| 10 | 90 | 0.01 | 15.18 | 9.87 | 6.98 | 17.24 | 1.18 | 43.05 |
| 11 | 100 | 0.04 | 15.69 | 10.11 | 6.36 | 18.84 | 0.94 | 40.91 |
| 12 | 120 | 0.01 | 8.88 | 14.65 | 8.53 | 24.53 | 1.53 | 31.82 |

*All reactions were conducted using either a 60% or the specified mole excess of TES (98%) vs. allyl chloride (98%) at either 80° C. or the specified temperature using 30 ppm Ru (RuCl₃ hydrate). GC data was not normalized for excess TES.

In Example 13 at ambient temperature, 32.52 g of TES was treated with 0.003 g of RuCl₃ hydrate (50 ppm Ru) and warmed. At ˜80° C., the TES solution was treated with 9.39 g of allyl chloride. After the allyl chloride addition was completed, the solution was maintained at 80° C. for 1 hour. An aliquot of the solution was analyzed with GC. The results were as follows:

| Allyl | | | | | | |
|---|---|---|---|---|---|---|
| chloride | (EtO)₃SiH | (EtO)₃SICl | (EtO)₄Si | (EtO)₃SIC₃H₇ | Cl(EtO)₂SiC₃H₇Cl | (EtO)₃SiC₃H₇Cl |
| 0.03 | 15.24 | 9.76 | 3.78 | 14.47 | 1.24 | 49.20 |

### EXAMPLES 14-19

Each reaction in Examples 14-19 was conducted by treating,1.6 mole equivalents (vs. allyl chloride) of TES at ambient temperature with the specified concentration of toluene, 15-50 ppm Ru (as a solid RuCl₃ hydrate or a 2-4% Ru ethanol/1,2-dimethoxyethane solution) versus total mass of the reaction. This solution was warmed. At ˜80° C., the solution was treated with 1.0 mole equivalent of allyl chloride. The solution's temperature was maintained at ˜80° C. throughout this addition. After the allyl chloride addition was completed, the solution's temperature was maintained at 80° C. for one hour. After this time, this solution was allowed to cool to ambient temperature, and an aliquot of the crude reaction was analyzed with GC.

In Example 18 at ambient temperature, 32.52 g of TES was treated with 0.0078 g of toluene, 0.003 g of RuCl₃ hydrate (50 ppm Ru) and warmed. At ˜80° C., the TES solution was treated with 9.39 g of allyl chloride. After the allyl chloride addition was completed, the solution was maintained at 80° C. for 1 hour. An aliquot of the solution was analyzed with GC. The results were as follows:

| Allyl | | | | | | |
|---|---|---|---|---|---|---|
| chloride | (EtO)₃SiH | (EtO)₃SICl | (EtO)₄Si | (EtO)₃SIC₃H₇ | Cl(EtO)₂SiC₃H₇Cl | (EtO)₃SiC₃H₇Cl |
| 1.39 | 34.45 | 4.77 | 5.55 | 14.02 | 0.49 | 48.41 |

The GC data for the affect of the toluene solvent on the reactions of Examples 14-19 are set forth in Table 2 as follows:

TABLE 2
GC data for the affect of toluene on the Ru-catalyzed hydrosilation reaction of TES and allyl chloride.*

| | [Toluene] | | | | | | | |
|---|---|---|---|---|---|---|---|---|
| | in TES | allyl | | | | | | |
| Example | (wt/wt) | chloride | (EtO)₃SiH | (EtO)₃SICl | (EtO)₄Si | (EtO)₃SIC₃H₇ | Cl(EtO)₂SiC₃H₇Cl | (EtO)₃SiC₃H₇Cl |
| 14 | 6000 ppm | 41.2 | 44.0 | 3.8 | 5.0 | 1.4 | 0.1 | 0.8 |
| | toluene | | | | | | | |
| 15 | 3000 ppm | 4.1 | 28.6 | 10.7 | 5.6 | 10.5 | 1.23 | 32.9 |
| | toluene | | | | | | | |
| 16 | 1500 ppm | 5.85 | 21.24 | 4.63 | 3.83 | 8.38 | 0.22 | 39.91 |
| | toluene | | | | | | | |
| 17 | 648 ppm | 2.98 | 25.86 | 5.69 | 5.06 | 12.88 | 0.29 | 43.35 |
| | toluene | | | | | | | |
| 18 | 188 ppm | 1.39 | 34.45 | 4.77 | 5.55 | 14.02 | 0.49 | 48.41 |
| | toluene | | | | | | | |
| 19 | 50 ppm | 0.03 | 13.22 | 10.40 | 6.21 | 15.09 | 1.86 | 44.32 |
| | toluene | | | | | | | |

*All reactions were conducted using either a 60% excess of TES (98%) vs. allyl chloride (98%) at 80° C. using 50 ppm Ru (RuCl₃ hydrate). GC data was not normalized for excess TES.

### EXAMPLES 21 AND 22

Each reaction in Examples 21 and 22 was conducted by treating 1.6 mole equivalents (vs. allyl chloride) of either methyldiethoxysilane (or dimethylethoxysilane) at ambient temperature with 15-100 ppm Ru (as a solid RuCl₃ hydrate or a 2-4% Ru ethanol/1,2-dimethoxyethane solution) versus total mass of the reaction. This solution was warmed. At ˜80° C., the solution was treated with 1.0 mole equivalent of allyl chloride. The solution's temperature was maintained at ˜80° C. throughout this addition. After the allyl chloride addition was completed, the solution's temperature was maintained at 80° C. for one hour. After this time, this solution was allowed to cool to ambient temperature, and an aliquot of the crude reaction was analyzed with GC.

In Example 21 at ambient temperature, 223.0 g of methyldiethoxysilane was treated with 0.081 g of RuCl₃ hydrate (103 ppm Ru) and warmed. At ˜80° C., the methyldiethoxysilane solution was treated with 78.91 g of allyl chloride. After the allyl chloride addition was completed, the solution was maintained at 80° C. for one hour. An aliquot of the solution was analyzed with GC. The results were as follows:

| Allyl | | | | | | Me(EtO)₂Si— |
|---|---|---|---|---|---|---|
| chloride | Me(EtO)₂SiH | Me(EtO)₂SICl | Me(EtO)₃Si | Me(EtO)₂SI—C₃H₇ | Cl(Me)(EtO)SiC₃H₇Cl | C₃H₇Cl |
| 0.01 | 12.58 | 3.77 | 15.82 | 6.04 | 1.08 | 48.98 |

Comparative GC data for Examples 13, 21 and 22 are set forth in Table 3 as follows:

TABLE 3
GC data of the Ru-catalyzed hydrosilation reaction with different silanes.*

| | | allyl | | | | | CIR′ₙR₂₋ₙSi— | R′ₙR₃₋ₙSi— |
|---|---|---|---|---|---|---|---|---|
| Example | Conditions | chloride | R′ₙR₃₋ₙSiH | R′ₙR₃₋ₙSiCl | R′ₙR₃₋ₙSi | propyl-SiR′ₙR₃₋ₙ | C₃H₇Cl | C₃H₇Cl |
| 13 | Triethoxysilane | 0.03 | 15.24 | 9.76 | 3.78 | 14.47 | 1.24 | 49.20 |
| 21 | Methyldiethoxy | 0.01 | 12.58 | 3.77 | 15.82 | 6.04 | 1.08 | 48.98 |
| | silane | | | | | | | |
| 22 | Dimethylethoxy | 21.1 | 8.6 | 12.6 | 24.1 | 5.0 | 0.2 | 3.5 |
| | silane* | | | | | | | |
| | (contained 1353 | | | | | | | |
| | ppm toluene) | | | | | | | |

*All reactions were conducted in a reverse addition using a 60% excess of R′n(R)₃₋ₙSiH vs. allyl chloride (98%) and 30 ppm Ru (RuCl₃ hydrate) at ˜80° C. followed by one hour at 80° C. GC data was not normalized for excess R′n(R)₃₋ₙSiH. An * indicates the reaction was conducted at the ˜bp of the specific silane.

### COMPARATIVE EXAMPLES 1-6

Comparative Examples 1-6 illustrate the reaction of allyl chloride and triethoxysilane employing other than ruthenium-containing catalysts. In Comparative Examples 1-6, each reaction was conducted by treating a solution consisting of 1.1 molar equivalents (vs. allyl chloride) of TES and 1.0 mole equivalents of allyl chloride at ambient temperature with a precatalyst and an additive. Typically, 50 ppm Ir as a 1.6% IrCl₃ hydrate ethanol solution versus total mass of the reaction was used as the precatalyst. This solution was warmed to 70° C. and maintained at that temperature for ˜18 hours. After this time, the solution was allowed to cool to ambient temperature and then analyzed with GC.

In Comparative Example 1 at ambient temperature, 4.17 g of triethoxysilane was treated with 1.59 g of allyl chloride and 0.014 g of IrCl₃ hydrate (50 ppm Ir) and warmed. This solution was maintained at ˜70° C. for 18 hours. An aliquot of the solution was analyzed with GC.

The GC data for Comparative Examples 1-4 showing the affects of the iridium-containing catalysts on the reactions are set forth in Table 4 as follows:

TABLE 4
Examples of the iridium-catalyzed hydrosilation reaction of triethoxysilane and allyl chloride.*

| Comparative | | Allyl | | | | (EtO)₃SI— | Cl(EtO)₂Si— | (EtO)₃Si— |
|---|---|---|---|---|---|---|---|---|
| Example | Precatalyst | chloride | (EtO)₃SiH | (EtO)₃SICl | (EtO)₄Si | C₃H₇ | C₃H₇Cl | C₃H₇Cl |
| 1 | IrCl₃Hydrate | 0.12 | 8.35 | 4.72 | 3.18 | 7.00 | 0.43 | 67.63 |
| 2 | IrCl₃Hydrate | 0.11 | 10.24 | 4.26 | 4.29 | 7.58 | 0.67 | 66.13 |
| 3 | H₂ IrCl₆Hydrate | 3.07 | 2.22 | 7.57 | 3.05 | 6.60 | 0.3 | 73.26 |
| 4 | [Ir(COD)Cl]₂ | 2.92 | 18.35 | 11.75 | 2.34 | 4.30 | 1.20 | 44.05 |

*A 10% mole excess of TES (98% purity) vs. allyl chloride (98% purity) and 50 ppm Ir was used for all reactions. All reactions were conducted under batch conditions at 70° C. for 18 hours using 10 mL reactotherm vials. GC data was not normalized for excess TES.

In comparative Example 5 at ambient temperature, 93.84 g of triethoxysilane was treated with 0.28 g of phenothiazine, 0.18 g of chloroplatinic acid solution (50 ppm Pt) and warmed. At 90° C., the triethoxysilane solution was treated with 38.99 g of allyl chloride, which was added over the course of one hour. After the allyl chloride addition was completed, the solution was maintained at 105 C for one hour. An aliquot of the solution was analyzed with GC. The results were as follows:

| Allyl | | | | | | |
|---|---|---|---|---|---|---|
| chloride | (EtO)₃SiH | (EtO)₃SICl | (EtO)₄Si | (EtO)₃SIC₃H₇ | Cl(EtO)₂SiC₃H₇Cl | (EtO)₃SiC₃H₇Cl |
| 12.54 | 24.65 | 27.66 | 4.29 | 3.89 | 9.96 | 9.43 |

In Comparative Example 6 at ambient temperature, 4.94 g of triethoxysilane was treated with 1.90 g of allyl chloride and 0.016 g of rhodium octoanate (63 ppm Pt) and warmed. This solution was maintained at ˜70° C. for 18 hours. An aliquot of the solution was analyzed with GC. The results were as follows:

| Allyl | | | | | | |
|---|---|---|---|---|---|---|
| chloride | (EtO)₃SiH | (EtO)₃SICl | (EtO)₄Si | (EtO)₃SIC₃H₇ | Cl(EtO)₂SiC₃H₇Cl | (EtO)₃SiC₃H₇Cl |
| 2.53 | 37.71 | 36.81 | 7.88 | 5.96 | 0.22 | 2.01 |

What is claimed is:

1. A process for preparing a haloalkylalkoxysilane of the formula
(R¹)ₓ(R²O)₃₋ₓSiCH₂CHR³CR⁴R⁵X
wherein R¹ is an alkyl of from 1 to 6 carbon atoms, R² is an alkyl of from 2 to 6 carbon atoms, R³ is an alkyl group of 1 to 6 carbon atoms or hydrogen, R⁴ is an alkyl of from 1 to 6 carbon atoms, hydrogen or halogen, R⁵ is an alkyl of from 1 to 6 carbon atoms or hydrogen and x is 0, 1 or 2, which comprises reacting in the substantial absence of aromatic solvent an olefinic halide of the formula
H₂C═CR³CR⁴R⁵X
wherein R³, R⁴, R⁵ and X have the aforestated meanings, with a molar excess of alkoxysilane of the formula
(R¹)ₓ(R²O)₃₋ₓSiH
wherein R¹ and R² and x have the aforestated meanings, in the presence of a catalytically effective amount of ruthenium-containing catalyst.

2. The process of claim 1 wherein the olefinic halide is selected from the group consisting of allyl chloride, allyl bromide, methallyl chloride, methallyl bromide, 3-chloro-1-butene, 3,4-dichloro-1-butene and 2-chloropropene.

3. The process of claim 1 wherein the alkoxysilane is selected from the group consisting of triethoxysilane methyldiethoxysilane, dimethylethoxysilane, ethydiethoxysilane, diethylethoxysilane, tripropyloxysilane, methyldipropyloxysilane and tributyloxysilane.

4. The process of claim 1 wherein the olefinic halide is allyl chloride and the alkoxysilane is triethoxysilane.

5. The process of claim 1 wherein the cumulative mole ratio of alkoxysilane to olefinic halide ranges from about 1.3 to about 3.0.

6. The process of claim 1 wherein the cumulative mole ratio of alkoxysilane to olefinic halide ranges from about 1.8 to about 2.3.

7. The process of claim 4 wherein the cumulative mole ratio of triethoxysilane to allylic chloride ranges from about 1.8 to about 2.3.

8. The process of claim 1 wherein the reaction is carried out at a temperature of from about 60 to about 130° C.

9. The process of claim 1 wherein the reaction is carried out at a temperature of from about 70 to about 80° C.

10. The method of claim 1 wherein the ruthenium-containing catalyst is selected from the group consisting of Ru₃(CO)₁₂, [Ru(CO)₃Cl₂]₂, cyclooctadiene-RuCl₂, RuCl₃, (Ph₃P)₂Ru(CO)₂Cl₂, (Ph₃P)₃Ru(CO)H₂, Ru on Fe, Ru on Al₂O₃, Ru on carbon, Ru(AcAc)₃, and RuBr₃.

11. The method of claim 1 wherein the amount of ruthenium present in the reaction medium is from about 5 to about 100 ppm by weight of the reactants.

12. The method of claim 1 wherein the amount of ruthenium-containing 2 catalyst present in the reaction medium is from about 15 to about 25 ppm by weight 3 of the reactants.

13. A process for preparing a chloroalkylethoxysilane of the formula
(CH₃CH₂)ₓ(CH₃CH₂O)₃₋ₓSiCH₂CHR³CR⁴R⁵Cl
wherein R³ is an alkyl of from 1 to 6 carbon atoms or hydrogen, R⁴ is an alkyl of from 1 to 6 carbon atoms, hydrogen or chlorine, R⁵ is an alkyl of from 1 to 6 carbon atoms or hydrogen and x is 0, 1 or 2, which comprises reacting in the substantial absence of aromatic solvent an olefinic chloride of the formula
H₂C═CR³CR⁴R⁵Cl
wherein R³, R⁴ and R⁵ have the aforestated meanings with an excess of an ethoxysilane of the formula
(CH₃CH₂)ₓ(CH₃CH₂O)₃₋ₓSiH
wherein x has the aforestated meaning in a cumulative mole ratio of ethoxysilane to olefinic chloride of from about 1.3 to about 3.0 at a temperature of from about 60 to about 130° C. in the presence of a ruthenium containing catalyst containing from about 5 to about 100 ppm ruthenium based on the total weight of the reactants.

14. The process of claim 13 wherein the olefinic chloride is allyl chloride.

15. The process of claim 13 wherein the ethoxysilane is triethoxysilane.

16. The process of claim 15 wherein the cumulative mole ratio of ethoxysilane to olefinic chloride is from about 1.3 to about 3.0.

17. The process of claim 13 wherein the reaction is carried out at a temperature of from about 70 to about 80° C.

18. The process of claim 13 wherein the ruthenium-containing catalyst is selected from the group consisting of RuCl₃ hydrate, Ru₃(CO)₁₂ and [RuCl₂(CO)₃]₂.

19. The process of claim 13 wherein the reaction medium contains from about 15 to about 25 ppm ruthenium based on the total weight of the reactants.

20. The process of claim 13 wherein the olefinic chloride is allyl chloride, the ethoxysilane is triethoxysilane, the cumulative mole ratio of triethoxysilane to allyl chloride is from about 1.6 to about 2.3, the reaction temperature is from about 70 to about 80° C., the ruthenium-containing catalyst is selected from the group consisting of RuCl₃ hydrate, Ru₃(CO)₁₂ and [RuCl₂(CO)₃]₂ and the reaction medium contains from about 15 to about 25 ppm ruthenium based on the total weight of the reactants.
